(19) United States
(12) Patent Application Publication
(10) Pub. No.: US 2023/0351447 A1
(43) Pub. Date: Nov. 2, 2023

(54) METHOD FOR PUBLISHING ADVERTISING INFORMATION AND A SYSTEM USING THE METHOD

(71) Applicant: Truckscreenia SRL, Bolzano (IT)

(72) Inventors: Alessandro PANCANI, Bolzano (IT); Francesco PANCANI, Bolzano (IT); Luciano DELMASTRO, Bolzano (IT); Paolo PINTO, Bolzano (IT)

(73) Assignee: Truckscreenia SRL, Bolzano (IT)

(21) Appl. No.: 18/041,078

(22) PCT Filed: Aug. 9, 2021
(86) PCT No.: PCT/EP2021/072126

§ 371 Date: Feb. 9, 2023

(30) Foreign Application Priority Data
Aug. 11, 2020 (IT) 102020000019969

(51) Int. Cl. G06Q 30/0251; G06V 20/58

(52) U.S. Cl. CPC G06Q 30/0266; G06Q 30/0252; G06V 20/58; G06V 2201/08

(57) ABSTRACT

A method for publishing advertising information comprising the following steps: (a) capturing an image; (b) deleting data which may result in a person and/or a vehicle; (c) deleting the image captured in step (a); (d) analysing the image produced in step (b); (e) deleting the image generated in step (b); (f) acquiring GNSS data and sensor data; (g) determining where in option A) the data remains unchanged, or in option B) the image is replaced by a random image from the land vehicle database after the capturing process in step a), and the captured image is deleted or the information obtained in step f) is replaced by a random image from the land vehicle database; (h) analysing the data obtained in step (d) and/or the data obtained in step (f); (i) selecting information based on the analysis (h) using predefined parameters in a database; (j) publishing the selected information.

### BACKGROUND OF THE INVENTION

The present invention relates to a method for publishing information in particular advertising information and a system using this method according to the claims.

### FIELD OF INVENTION

The technical field into which the method according to the invention fits is the information, in particular advertising information for moving vehicles adapted by means of collected and processed data. There is a multitude of systems and methods allowing personalization of information, especially advertising, according to the data collected by the systems. This information must be adapted according to environmental parameters and individual parameters of the information target.

### STATE OF ART

From publication U.S. Pat. No. 9,147,192 a system is known which uses a first database and a second database in which the first database presents advertising information and the second database provides information relating to the position and speed of the vehicle which has the system on board.

The described system comprises a sensor, a processor and a display. The sensor collects data and the processor combines this data with advertising information which is then transmitted to the display. In particular, the sensor tries to detect personal data such as, for example, the license plate or other means to unambiguously identify the vehicle carrying the recipients of the advertising and if this identification is successful, the advertising is personalized according to the identified user. If this identification is unsuccessful, general non-personalized advertising is shown.

This system has some major problems since generally the collection of data, especially personal data, without consent can lead to a violation of the privacy code and/or of laws protecting people's privacy. In particular, this personal data cannot be saved as this violates privacy laws.

US20120303458 discloses a system and method for displaying digital messages and images on a flat screen on the rear or side walls of a moving vehicle using GPS with an antenna, a memory control unit, devices for wireless transmission and data reception to communicate with an external control system. The system features software programmed to change the image transmitted on the screen based on geo-location data. The screen has in a preferred embodiment sections for representing information of public interest, brake lights, and arrows for showing the forward direction of the vehicle. The system also features a counter to determine the number of potential readers of the information on the screen to establish a fee to be paid by the customer showing the advertisement per 1000 (one thousand) potential users.

In publication US20120303458 the problem of the size of the file/s to be processed is raised.

No methods of identifying potential users and tailoring advertising to them are described in this publication. The only way to choose advertising makes use of the location of the vehicle.

In the present description, a carrier vehicle is understood to mean a truck, trailer or trailer, small van or van and the likes of these, on which the system according to the invention is present and/or the method according to the invention is carried out at least partially.

In the present description, by observing vehicle we mean the vehicle and/or vehicles of which images/data used by the system according to the invention and/or by the method according to the invention are acquired.

### SUMMARY OF THE INVENTION

The object of the present invention is to implement a method for publishing information in particular advertising information and a system using this method.

This object is achieved by a method for publishing information in particular advertising information according to the claims.

A method is therefore proposed for the dissemination of information, in particular advertising information, for carrier vehicles. These carrier vehicles are equipped with at least one device, e.g. screen and/or the like, for publishing information, in particular advertising information. Furthermore, at least one device for capturing images, for example a camera, video camera and/or the like, is placed on the carrier vehicle, preferably on the rear of the carrier vehicle. Furthermore, there are a number of sensors for locating the carrier vehicle, for example a GNSS sensor (GPS, Galileo, GLONASS, or similar), and other sensors for detecting environmental conditions. GNSS stands for Global Navigation Satellite System, GPS stands for Global Positioning System and also GLONASS stands for Global Navigation Satellite System. These additional sensors can detect weather conditions, road conditions and other factors that may be of interest.

Reducing the file size by deleting unnecessary data produces a tangible technical effect, furthermore inserting a random image makes the data obtained usable for publishing information Aforementioned file size reduction reduces the entropy of the image. For the present application we mean by entropy the Shannon entropy which is a measure of the amount of information contained in a message.

The images in their original form before being modified by the method of the present application are provided with a readable license plate and therefore have on average a higher information value, and therefore a higher Shannon entropy, than those images which have been modified by the method according to the invention. The difference in information value also relates to parts that have no relevance for the purpose of recognizing the type of car.

Therefore, after the method according to the present invention, the system is presented with information cleaned of parts which from the point of view of the vehicle type recognition algorithm constitute exclusively noise. The task of the recognition algorithm is therefore simplified.

This method of modifying and reducing the size of data (Shannon entropy) cannot be done purely mentally.

The method according to the invention for publishing information, in particular advertising information, for carrier vehicles comprises the following steps which may vary in their order:
a) acquisition of an image;
b) deletion of data that may result in the unambiguous identification of a person and/or vehicle from the image,
c) deletion of the image acquired in phase a),
d) analysis of the image generated in phase b)
e) deletion of the image generated in phase b),
f) GNSS data collection and sensors,
g) determination by random/random generator and by pre-set parameters,
option A) the data is kept unchanged
or
option B) the image is replaced after the acquisition in phase a) by a random image from the land vehicle database e
   the acquired image is canceled or the information obtained in phase f) is replaced by random information from the database,
h) analysis of data obtained in phase d) and/or data obtained in phase f)
i) selection of a piece of information based on the analysis h) using predetermined parameters in a database,
j) publication of the selected information,

Further phases can be added to this method or the order of the phases changed without thereby leaving the scope of protection.

The image acquisition device acquires an image of the road, preferably of the carriageway behind the carrier vehicle by photographing with the system according to the invention one or more of the observing vehicles which follow. This image is preferably created in a direction opposite to the direction of travel of the carrier vehicle. In one embodiment, multiple devices for acquiring an image are preferred.

After the acquisition of the image, this is sent to a central calculation unit which, by means of a probability generator, chooses whether to process the image or delete the acquired image and, in order to reduce the probability of re-identification thus safeguarding privacy of the people of the observing vehicle, replace the same with a random image present in the archive or with random information.

By re-identification we mean identification through a series of elements which, combined with each other, can lead to identification. This phase can also be replaced directly by inserting a random advertisement without adding a random photo present in the archive from a land vehicle database. In both cases, the advertisement or the information published gets chosen from the archive of a land vehicles database, this meaning a database of vehicles whose image is likely to be acquired and therefore allows to render a small part of the random advertisement. Advantageously, this choice of inserting an image/information from the archive from a land vehicle database and/or inserting an advertisement directly from the archive without processing the data is thus limited by giving the client who gives the assignment to publish the advertisement or information the security that aforementioned client's advertising or information is published for the observing vehicle for a guaranteed minimum number of cases.

If the image captured by imaging devices is processed in a first stage, this image goes through a personally identifying elements removal process. In this phase, elements are identified that can uniquely identify an observing vehicle, for example the license plate of the observing vehicle is cancelled. Furthermore, only if necessary, the silhouettes of people on the image are identified and the information in reference to these people is also deleted, i.e. the image is modified to eliminate data that could identify people.

From this image, only if necessary, the data relating to people or objects that uniquely identify a person, for example a passer-by, can be eliminated too.

After this personal data removal phase, the processed image or the random image is associated with GNSS data, and then associated with further data, for example data referring to weather conditions, the environment, road conditions, etc.

The image with associated data is then sent to a server, only if needed, and the image data is deleted from local storage.

By means of a database, the observing vehicle and other relevant data for the information to be published are identified. For example, vehicle type (station wagon, convertible, suv) and vehicle brand (Audi, BMW, Fiat, etc.), model (A3, 1 series, Panda), color (blue, red, yellow) and, if applicable, the year of production.

In a further phase, an advertisement aimed at the observing vehicle is selected using pre-set parameters on the basis of the information acquired and the probabilistic values of appreciation for a certain type of advertising by the users of the selected observing vehicle type contained in a proprietary database. This advertisement is then sent to a screen or the like which is present on the carrier vehicle. According to the invention in any case the image acquired in the first phase is always deprived of personal identification data before being sent to an external device, preferably the image captured is never saved but is processed while it is still in the processing memory. This allows you to avoid saving data referring to people or objects that could be in conflict with privacy legislation since the described and claimed method does not require the saving of data relevant to privacy, while still guaranteeing a display of precise information tailored to the user.

### DESCRIPTION OF THE DRAWINGS

The further characteristics and details of the invention result from the claims and from the following description of a preferred non-limiting embodiment, represented in the attached drawings:

FIG. 1: shows a first flow diagram of a method according to the invention,

FIG. 2: shows a second flow chart of a method according to the invention,

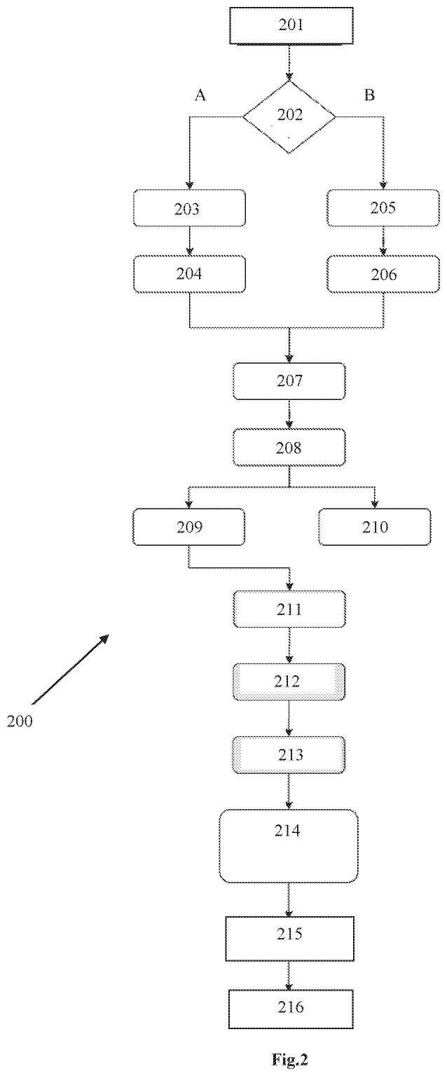

FIG. 3: shows a third flow chart of a method according to the invention.

### DETAILED DESCRIPTION OF THE INVENTION

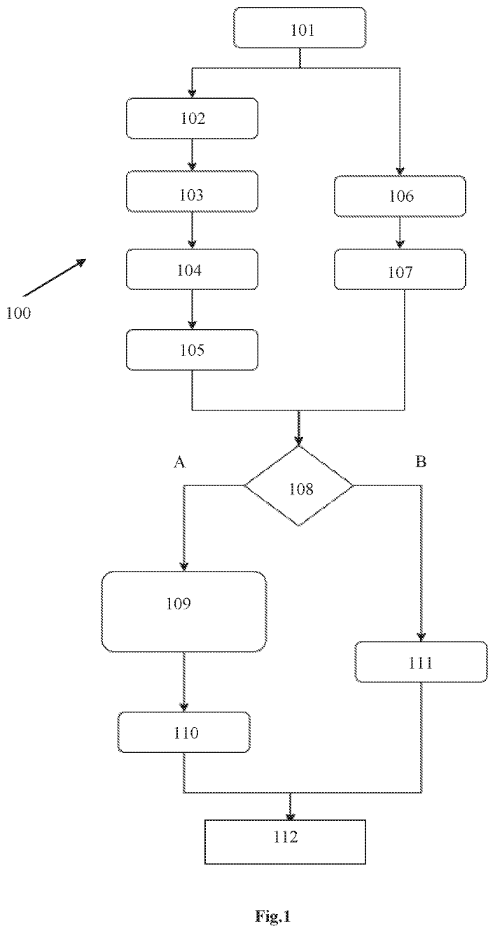

In FIG. 1, the reference number 100 indicates a flow chart of a first method according to the invention in which in the first step 101 an image is acquired, for example by means of a camera, from the carrier vehicle. The image is preferably acquired in the opposite direction to the direction of travel of the carrier vehicle.

In step 102 the acquired image is modified if necessary. This means that the image is processed by deleting the data that can lead to the unique identification of an observing person and/or vehicle. In this phase, for example, the license plate of an observing vehicle is cancelled. In step 103 the original photo is deleted. This happens without the original photo being saved.

In a subsequent step 104 the image, which in step 102 had already been deprived of personal identification data, is analyzed and is processed. In this phase, for example, the type of vehicle being observed is identified, such as for example a convertible, SUV, truck, etc. or other elements such as, for example, the make of the vehicle: Mercedes, Audi, VW, etc. After identification of the predetermined relevant data in the image, the processed image is also deleted. Simultaneously with the steps 102 to 105, the data for example of the position of the carrier vehicle are determined in the step 106 by means of a GNSS device and other data are acquired by sensors in the step 107. This further data can be, for example, the amount of light, the characteristics of the surrounding environment, temperature, weather, road conditions, etc.

This data is paired with the data retrieved from the image cleansed of personally identifying data.

In the next step, 108, the system makes a random choice, adds “statistical noise” according to pre-set parameters to the data detected in step 107. In step 109, the data, original or altered in step 108, are analyzed together with the data retrieved from the sensors in the step 106 and 107 to choose an advertisement in step 110.

If by probabilistic choice in step 108 the data retrieved previously are deleted, an advertisement/information is chosen at random from the database of land vehicles in step 111.

In step 112, advertising or information selected according to the method in a first embodiment is displayed on a device, for example a screen installed on a carrier vehicle. This first embodiment does not require a connection to external databases and the whole process or method is performed locally on the carrier vehicle itself. This is particularly advantageous since the system can hardly be subjected to external attack and possibly manipulated to use the sensors, in particular the devices to acquire the image or to retrieve information or to carry out unwanted surveillance. For this reason, the operator and/or owner of the system according to the invention easily fulfills the strict rules for the management of personal data regarding privacy.

However, access from the outside can always take place to the parameter structure and/or database of the system. In this way, the information to be published or the parameters that regulate the system can be modified. Furthermore, statistical data can be derived in this way.

In a second embodiment illustrated in the second diagram 200 of the method according to the invention, an image is acquired in step 201. Subsequently, one passes to step 202 in which, based on the result of a random number generator and pre-set parameters, it is chosen whether the captured image is routed according to path A or path B.

During path A the personal identification data are eliminated in step 203 and then in step 204 the original image, i.e. with the data which refer to the person or which allow an identification as previously described in step 102 is eliminated.

If path B is chosen in step 202, the original image is immediately canceled in step 205 and replaced with a plausible random image in step 206 present in the database of land vehicles, for the purpose of decreasing the probability of re-identification thus safeguarding privacy of the people of the observing vehicle, replace the same with a random image present in the archive or with random information.

At the end of step 204 or 206, step 207 is performed. In this case, the GNSS data suitable for identifying the position of the carrier vehicle are associated with the image created in step 203 or with the image retrieved from the database in step 206. Then in step 208 the data from the other sensors are added to the image as previously described in the first embodiment of the method at 106 and 107.

In step 209 the image with the respective data is sent by means of a wireless system, for example by means of a data connection in the mobile telephony network and/or the like to an external server. Simultaneously in step 210 the image and data are deleted locally, i.e. on the device.

In step 211 the image with the data is processed on the external server by extracting the characteristics of the vehicle and, in step 212, the analyzed photo is deleted from the external server

In step 213 the characteristics of the observing vehicle are associated with the data coming from the GNSS system and the sensors. In step 214, the previously associated data are analyzed. Subsequently, in step 215, information, for example, an advertisement is selected from a database containing the information and advertisements likely to be shown on the screens.

This information is then sent to the system present on the carrier vehicle and then in step 216 displayed on, for example, a screen attached to one of the sides preferentially on the rear side of the carrier vehicle.

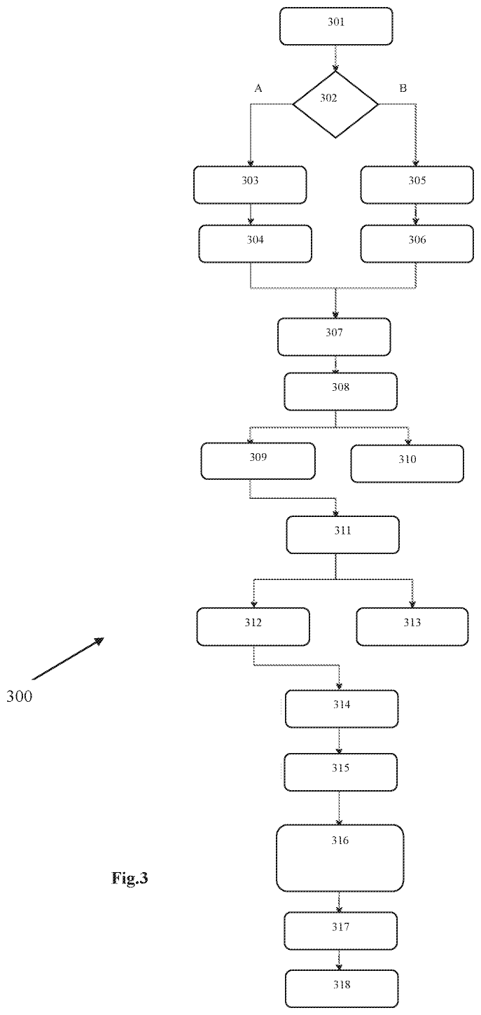

In a third form of implementation of the method according to the invention in FIG. 3 a scheme 300 is illustrated in which in step 301 an image is acquired by means of a special device arranged on a carrier vehicle. In step 302 either a path A or a path B is selected through a random generator and by preset parameters. Along path A the captured image is, during step 303, stripped of personal identification elements as described in step 102 and then in step 304 the original photo, i.e., with data referring to the person or allowing an identification, is deleted.

If path B is chosen in step 302, the original image is immediately deleted in step 305 and replaced, in step 306, with a random image present in the land vehicle database.

At the end of step 304 or 306, step 307 is carried out, in which the GNSS data to identify the position of the carrier vehicle are associated with the image created in step 303 or with the image retrieved from the database in step 306. Then in step 308 the data from the other sensors are retrieved and associated with the previous ones, as previously described in the first embodiment of the method 106 and 107.

In step 309 the image is sent by means of a wireless system, for example by means of a data connection in the mobile telephony radio network and/or similar to an external server. Simultaneously in step 310 the image and data are locally erased.

In step 311 the image with data is processed on the external server, analyzed in step 312 and deleted in step 313.

In step 314, pre-selected information are sent, i.e. a series of information, that has been selected according to the analysis in step 312 according to the pre-set parameters.

In step 315, the data that has been retrieved from the sensors and from the GNSS is analyzed, these are associated, and in step 316, analyzed together with the pre-selected information that has been sent from the external server that has been selected and sent in step 309.

The information to be published in step 317 is selected locally on the device, in particular the advertising to be shown on at least one screen. In step 318 this selected information is displayed on at least one screen located on the carrier vehicle.

By means of this third method according to the invention no location-related data and/or other locally retrieved data are made accessible externally.

To implement one of the methods described above according to the invention, the system must comprise at least one device for acquiring images arranged on the carrier vehicle, a calculation unit for processing the image, a GNSS device for detecting the position of the observing vehicle installed on the carrier vehicle, a database for selecting an advertising image or information, a display device in particular a screen fixed to one side of the carrier vehicle preferably located at the rear of the carrier vehicle, and a power supply system. Advantageously, a series of sensors are arranged on the carrying vehicle for detecting the environmental and road conditions.

Finally, it is clear that additions, modifications or variations which are obvious to a person skilled in the art can be applied or added to the method and system described up to now without thereby departing from the scope of protection provided by the appended claims. In particular, the single steps of the method can be performed in different order.

### REFERENCE NUMBERS

100 flowchart of a first method
101-112 steps of a first method according to the invention
200 flowchart of a second method 201-216 phases of a second method according to the invention
300 flowchart of a third method
301-318 steps of a third method according to the invention

1. A method for the publication of advertising information for carrier vehicles comprising the following steps:
a) acquisition of an image (101,201,301);
b) deletion of data that may lead to the unique identification of a person and/or vehicle from the image (102,203,303),
c) cancellation of the acquired image (103,204,304) in step a,
d) analysis of the image (104,211,312) generated in step b,
e) deletion of the image (105,212,313) generated in phase b),
f) GNSS (106,207,307) and sensors (107,208,308) data collection
g) determination by a random generator (108,202,302) and by pre-set parameters
option A) the data is kept unchanged
or
option B) the image is replaced after the acquisition in step a by a random image from the database (206,306) of land vehicles and
the acquired image is deleted (205,305) or the information obtained in step f) is replaced by random information from the database of land vehicles (111),
h) data analysis (109,214,316) obtained in step d and/or data obtained in step f,
i) selection of information based on step h using predetermined parameters in a database (110, 215,317),
j) publication of the selected information (112,216,318).

2. The method for publishing information according to claim 1, wherein all steps are performed on the carrier vehicle.

3. The method for publishing information according to claim 1, wherein step d) analysis of the image (211,312) generated in step b and step e deletion of the image (212,313) generated in step b, are performed on a device external to the carrier vehicle.

4. The method for the publication of information according to claim 3, wherein an additional step k preselects a set of information (314) for publication which is used for the selection in step i.

5. A system for implementing the method according to claim 1, wherein the fact that on a carrier vehicle there is at least one device for acquiring images, one computing unit for processing an image, one GNSS device for detecting the position of an observing vehicle and/or the carrier vehicle, a database for selecting an advertising image or information, a screen fixed to one side of the carrier vehicle and a feeding system.

6. The system for implementing the system according to claim 5, wherein it further comprises sensors for detecting environmental and meteorological conditions.

7. The system for implementing the system according to claim 5, wherein it comprises sensors for detecting road conditions.

8. The system for implementing the system according to claim 5, wherein it comprises at least one data connection device.
